(19) United States
(12) Patent Application Publication
(10) Pub. No.: US 2026/0220220 A1
(43) Pub. Date: Jul. 30, 2026

(54) METHOD AND SYSTEM FOR AUGMENTING MIXED SIGNAL

(71) Applicant: Panasonic Intellectual Property Management Co., Ltd., Osaka (JP)

(72) Inventors: ZONG SHENG TANG, Singapore (SG); PHILIP HANN YUNG LEE, Singapore (SG); ARIEL BECK, Singapore (SG); SAHIM YAMAURA, Singapore (SG); TOSHIHIRO SAKAMOTO, Osaka (JP); HIROMU KITAJIMA, Hyogo (JP)

(21) Appl. No.: 19/036,094

(22) Filed: Jan. 24, 2025

(51) Int. Cl. G06F 17/11; G06N 20/00

(52) U.S. Cl. CPC G06F 17/11; G06N 20/00

(57) ABSTRACT

A method (400) and a system (100) for augmenting a mixed signal is disclosed. The method (400) includes sensing a set of single signals and the mixed signal. Further, the method (400) includes inputting the set of single signals and the mixed signal on a fitting function based on selecting the set of single signals and the mixed signal. The method (400) further includes determining fitting parameters based on fitting the mixed signal with the set of single signals. Furthermore, the method (400) includes updating the fitting parameters. Moreover, the method (400) includes augmenting the mixed signal based on determining an updated set of fitting parameters.

### TECHNICAL FIELD

The present disclosure relates to data augmentation, and more particularly, to a method and a system for augmenting a mixed signal for training an artificial intelligence (AI) model.

### BACKGROUND

The information in this section merely provides background information related to the present disclosure and may not constitute prior art(s) for the present disclosure.

Data collection is the first step in a decision-making process, driven by machine learning models. In machine learning models, data collection precedes stages such as data cleaning and preprocessing, model training and testing, and decision making based on a model's output. Additionally, the data collection is also a critical step in sensor design.

For data collection, signal is received from multiple stimulant which result in concurrent mixed responses from multiple sources.

Therefore, by adding more sources to the data collection process, the number of potential permutations or combinations of data increases exponentially. Each additional source introduces more potential interactions or variations, making it harder to capture and analyze all relevant patterns. This exponential growth in permutations significantly strains the developer's time and resources which is an expensive and time-consuming process.

Therefore, there is a need for an alternative solution that may overcome above discussed limitations and provide an improved method and system for augmenting the mixed signal for training an artificial intelligence (AI) model such as the machine learning model.

The drawbacks, difficulties, disadvantages, or limitations of the conventional techniques explained in the background section are just for exemplary purposes and the disclosure would never limit its scope only such limitations. A person skilled in the art would understand that this disclosure and below mentioned description may also solve other problems or overcome the other drawbacks/disadvantages.

### SUMMARY

This summary is provided to introduce a selection of concepts, in a simplified format, that are further described in the detailed description of the invention. This summary is neither intended to identify essential inventive concepts of the invention nor is it intended for determining the scope of the invention.

According to an aspect of the present disclosure, a method for augmenting a mixed signal is disclosed. The method includes sensing a set of single signals and the mixed signal. Further, the method includes inputting the set of single signals and the mixed signal on a fitting function based on selecting the set of single signals and the mixed signal. The method further includes determining fitting parameters based on fitting the mixed signal with the set of single signals. Furthermore, the method includes updating the fitting parameters. Moreover, the method includes augmenting the mixed signal based on determining an updated set of fitting parameters.

According to another aspect of the present disclosure, a system for augmenting a mixed signal is disclosed. The system includes a memory. The system further includes at least one processor in communication with the memory. The at least one processor is configured to sense a set of single signals and the mixed signal. Further, the at least one processor is configured to input the set of single signals and the mixed signal on a fitting function based on selecting the set of single signals and the mixed signal. The at least one processor is configured to determine fitting parameters based on fitting the mixed signal with the set of single signals. Furthermore, the method includes updating the fitting parameters. Moreover, the at least one processor is configured to augment the mixed signal based on determining an updated set of fitting parameters.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates a schematic block diagram depicting an environment for the implementation of a system for augmenting a mixed signal, in accordance with an embodiment of the present disclosure;

FIG. 2 illustrates a schematic block diagram of the system for augmenting the mixed signal, in accordance with an embodiment of the present disclosure;

FIG. 3 illustrates a process flow diagram depicting blocks for augmenting the mixed signal, in accordance with an embodiment of the present disclosure;

FIG. 4 illustrates a flowchart depicting an exemplary method for augmenting the mixed signal, in accordance with an embodiment of the present disclosure; and

FIG. 5 illustrates a flowchart depicting sub-steps for generating one or more ellipsoids, in accordance with an embodiment of the present disclosure;

FIG. 6 illustrates an exemplary graphical representation of a generated ellipsoid, in accordance with an embodiment of the present disclosure;

FIG. 7 illustrates a flowchart depicting sub-steps for estimating the set of unseen distribution parameters, in accordance with an embodiment of the present disclosure;

FIG. 8 illustrates an exemplary graphical representation of an updated ellipsoid, in accordance with an embodiment of the present disclosure; and

FIG. 9 illustrates a flowchart depicting sub-steps for augmenting the mixed signal, in accordance with an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF EMBODIMENT

For the purpose of promoting an understanding of the principles of the invention, reference will now be made to the various embodiments, and specific language will be used to describe the same. It should be understood at the outset that although illustrative implementations of the embodiments of the present disclosure are illustrated below, the present invention may be implemented using any number of techniques, whether currently known or in existence. The present disclosure is not necessarily limited to the illustrative implementations, drawings, and techniques illustrated below, including the exemplary design and implementation illustrated and described herein, but may be modified within the scope of the present disclosure.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

It is to be understood that as used herein, terms such as, “includes,” “comprises,” “has,” etc. are intended to mean that the one or more features or elements listed are within the element being defined, but the element is not necessarily limited to the listed features and elements, and that additional features and elements may be within the meaning of the element being defined. In contrast, terms such as, “consisting of” are intended to exclude features and elements that have not been listed.

The embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

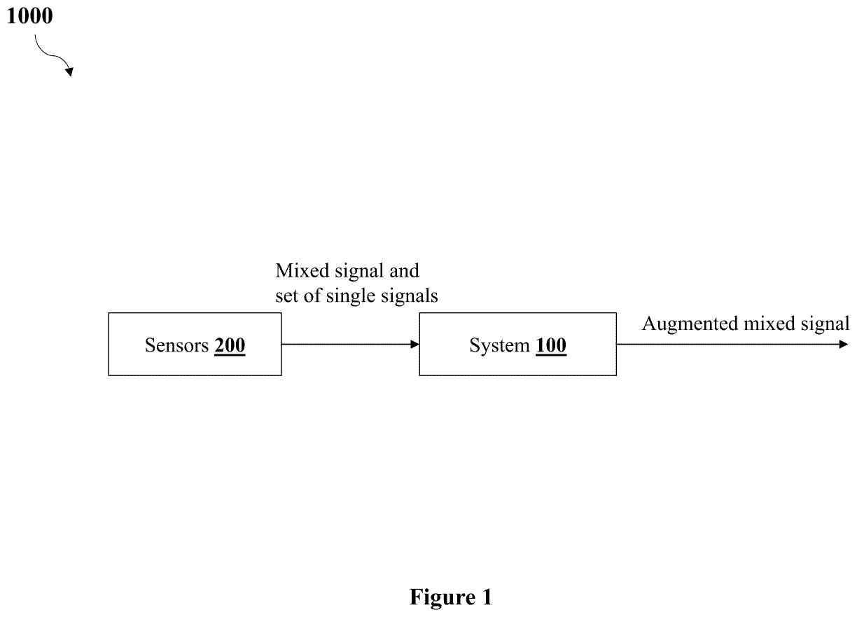

FIG. 1 illustrates a schematic block diagram depicting an environment 1000 for the implementation of a system 100 for augmenting a mixed signal. In an embodiment, “augmenting the mixed signal” refers to enhancing or improving the performance of mixed signal systems that handle both analog and digital signals. For instance, in many applications, a “mixed signal” system combines the characteristics of both analog and digital circuits to process real-world signals such as audio, video, or sensor data.

In an embodiment, the environment 1000 may include one or more sensors 200 adapted to sense a set of single signals and the mixed signal. In an embodiment, the one or more sensors 200 may alternatively be referred to a sensor 200 within the scope of the present disclosure. The environment 100 may further include the system 100 configured to receive the set of single signals and the mixed signal. The system 100 may be configured to process the set of signals with the mixed signal to augment the mixed signal by utilizing an updated set of fitting parameters. In an embodiment, the updated set of fitting parameters may be input into a fitting function to augment the mixed signal The present disclosure may be explained in detail in the below paragraphs of the description.

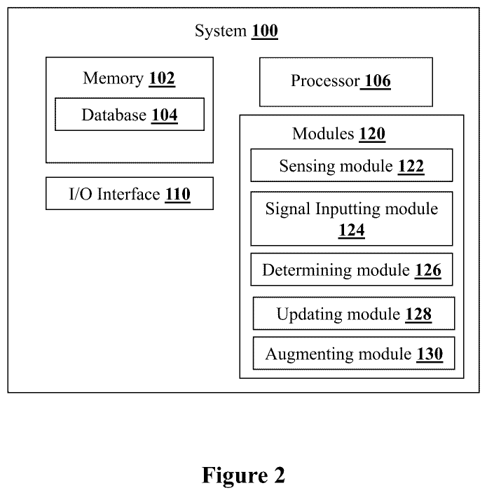

FIG. 2 illustrates a schematic block diagram of the system 100 for augmenting the mixed signal, in accordance with an embodiment of the present disclosure.

In an embodiment, the system 100 may include a memory 102 including a database 104, a processor 106 communicatively coupled with the memory 102, an Input/Output (I/O) interface 110, and a plurality of modules 120. In an embodiment, the system 100 may be implemented by a User Equipment (UE). In a non-limiting example, the UE may be a smartphone, a laptop computer, a desktop computer, a Personal Computer (PC), a notebook, a tablet, or a smartwatch.

In another embodiment, the system 100 may be a cloud-based system, that may include the server, specifically a cloud server. In yet another embodiment, the system 100 may be implemented by a combination of the UE and the server.

In one embodiment, the memory 102 is configured to store instructions executable by the processor 106. In one embodiment, the memory 102 communicates via a bus within the system 100. The memory 102 includes but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory includes a cache or random-access memory (RAM) for the processor 106. In alternative examples, the memory 102 is separate from the processor 106 such as a cache memory of a processor, the system memory, or other memory. The memory 102 is an external storage device or the memory 102 is for storing data. The memory 102 is operable to store instructions executable by the processor 106. The functions, acts, or tasks illustrated in the figures or described are performed by the programmed processor for executing the instructions stored in the memory 102. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies include multiprocessing, multitasking, parallel processing, and the like.

As a non-limiting example, the processor 106 may be a single processing unit or a set of units each including multiple computing units. The processor 106 may be implemented as one or more microprocessors, microcomputers, microcontrollers, digital signal processors, central processing units, state machines, logic circuitries, and/or any devices that manipulate signals based on operational instructions (computer-readable instructions) stored in the memory 102. Among other capabilities, the processor 106 may be configured to fetch and execute computer-readable instructions and data stored in the memory 102. The processor 106 includes one or a plurality of processors. The plurality of processors is further implemented as a general-purpose processor, such as a central processing unit (CPU), an application processor (AP), or the like, a graphics-only processing unit, such as a graphics processing unit (GPU), a visual processing unit (VPU), and/or an AI-dedicated processor such as a neural processing unit (NPU). The plurality of processors controls the processing of the input data in accordance with a predefined operating rule or an artificial intelligence (AI) model stored in the memory 102. The predefined operating rule or the AI model is provided through training or learning.

The processor 106 may be disposed in communication with one or more input/output (I/O) devices via the Input/Output (I/O) interface 110. The I/O interface 110 employs communication code-division multiple access (CDMA), high-speed packet access (HSPA+), global system for mobile communications (GSM), long-term evolution (LTE), WiMax, and the like, etc. In another embodiment of the present invention, the I/O interface 110 employs ethernet, industrial wireless Local Area Network (LAN), Process Field Bus (PROFIBUS), Actuator Sensor (AS) Interface, and the like.

The plurality of modules 120 may include the one or more instructions (stored in a memory 102) that may be executed to cause the system 100, in particular, the processor 106 of the system 100, to perform the one or more functions/methods, as discussed here in the present disclosure. In one embodiment, the plurality of modules 120 may be implemented at least in part as hardware, which may work in conjunction with the instructions to perform the functions/methods discussed herein.

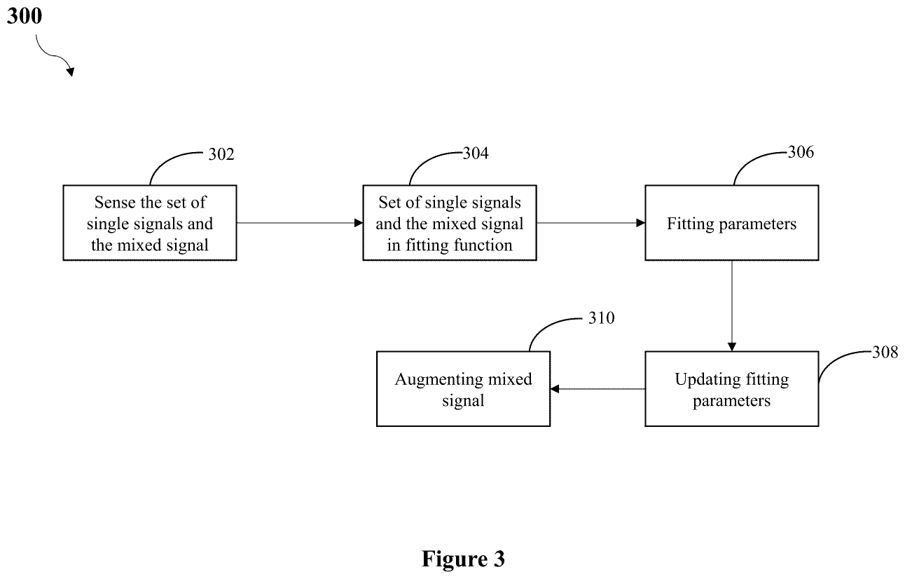

The plurality of modules 120 may include a sensing module 122, a signal inputting module 124, a determining module 126, an updating module 128, and an augmenting module 130. In an embodiment, the sensing module 122, the signal inputting module 124, the determining module 126, the updating module 128, and the augmenting module 130 may be in communication with each other. The working of the plurality of modules 120 may be explained in conjunction with FIG. 3.

FIG. 3 illustrates a process flow diagram 300 depicting blocks for augmenting the mixed signal, in accordance with an embodiment of the present disclosure.

At block 302, the sensing module 122 may be configured to sense the set of single signals and the mixed signal. In an embodiment, the sensing module 122 may use the sensor 200 to sense the set of single signals and the mixed signal.

At block 304, the signal inputting module 124 may be configured to input the set of single signals and the mixed signal on the fitting function. In an embodiment, the set of single signals and the mixed single may be selected and may be input in the fitting function for determining an optimum fitting parameters.

Further, at block 306, the determining module 126 may be configured to determine fitting parameters. In an embodiment, the fitting parameters may be determined upon the fitting of the mixed signal with the set of single signals. The fitting may be performed using predefined fitting techniques such as least square fitting technique.

Furthermore, at block 308, the updating module 128 may be configured to update the fitting parameters. In an embodiment, the fitting parameters may be updated based on fitting a plurality of combinations of the mixed signal with the set of single signals for a predefined number of times.

Moreover, at block 310, the augmenting module 130 may be configured to augment the mixed signal. In an embodiment, an updated set of fitting parameters may be obtained that may be input into the fitting function to augment the mixed signal. In an embodiment, the augmented data associated with the mixed signal may be utilized to train the AI model.

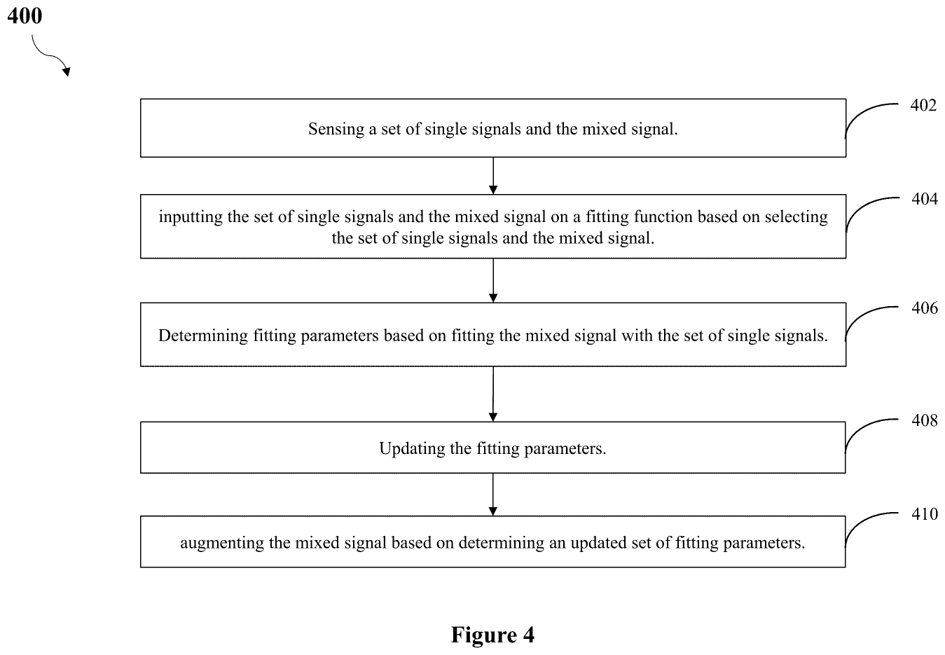

Now, the present disclosure is explained in detail in reference to a method 400 disclosed in FIG. 4. More specifically, referring to FIGS. 1-4 in combination, the various steps of the method 400 as described hereinafter may be executed in the system 100, or specifically in the processor 106 of the system 100, for augmenting the mixed signal.

FIG. 4 illustrates a flowchart depicting an exemplary method 400 for augmenting the mixed signal, in accordance with an embodiment of the present disclosure. In an embodiment, the method 400 is a computer-implemented method 400 that is explained in detail in the below paragraphs.

In an embodiment, the method 400 may begin with step 402 which may include sensing the set of single signals and the mixed signal. In an embodiment, the set of single signals and the mixed signal may be sensed by the sensor 200. In an embodiment, the set of single signals may be received from single sources, which means each source generates its own specific signal. For instance, each source provides one signal, which represents an output of that source. Further, mixed signal may be received from multiple sources, which refers to a situation where signals from different sources may be combined, into a single output or dataset.

In an embodiment, the sensor 200 may provide a monotonic response function with respect to stimulant strength of the single sources. In an embodiment, the sensor 200 may provide a monotonic response with respect to multiple stimulant strength of the multiple sources.

Further, at step 404, the method 400 may include inputting the set of single signals and the mixed signal on a fitting function based on selecting the set of single signals and the mixed signal. In an exemplary embodiment, at least two single signals are selected, and one mixed signal is selected.

In an exemplary scenario, x_{C} and x_{D} are selected as the single signals which may be alternatively referred to as arbitrary single source signals. In an embodiment, these signals are 1-dimensional (1D) vectors of a same fixed length. In an embodiment, the fitting function may be represented as equation 1 below:

$$f ( {α}_{C} , {x}_{C} , {α}_{D} , {x}_{D} , β ) \qquad ( 1 )$$

Where α_{C}, α_{D}=initial fitting parameters
x_{C}, x_{D}=single signals represented in 1D vector

In an embodiment, the fitting function may be selected that may accept the at least two single signals from distinct simulant sources (Nₛ) such that the output of the function is a time series signal that has a same length as both the single signals.
Where, Nₛ represents number of distinct simulant sources, and Nₛ≥2

Further, at step 406, the method 400 may include determining fitting parameters based on fitting the mixed signal with the set of single signals. In an embodiment, the fitting of the mixed signal with the set of signals may be represented using an equation 2 as below:

$${x}_{CD} = f ( {α}_{C} , {x}_{C} , {α}_{D} , β ) \qquad ( 2 )$$

Where x_{CD} represents the mixed signal

In an embodiment, the fitting parameters that may be optimal for the mixed signal may be determined using a predefined optimization model. In an exemplary scenario, the fitting parameters may be determined using as equation 3 as below:

$${α}_{C}^{′} , {α}_{D}^{′} = arg {min}_{{α}_{k}} ( {x}_{C D} - f ( {α}_{C} , {x}_{C} , {α}_{D} , {x}_{D} , β ) ) \qquad ( 3 )$$

Where,

$${α}_{C}^{′} , {α}_{D}^{′}$$

represents the determined fitting parameters

In an embodiment, the fitting function may be defined using equation 4 as below, representing a polynomial of degree n (maximum exponent) which may approximate complex relationships:

$$f ( {α}_{C} , {x}_{C} , {α}_{D} , {x}_{D} , β ) = {\sum }_{k = 1}^{n} ( {α}_{C , k} {x}_{C}^{k} + {α}_{D , k} {x}_{D}^{k} ) + β where {\sum }_{k = 1}^{n} ( {α}_{C , k} {x}_{C}^{k} + {α}_{D , k} {x}_{D}^{k} ) = {α}_{C , 1} {x}_{C}^{1} + {α}_{D , 1} {x}_{D}^{1} + {α}_{C , 2} {x}_{C}^{2} + {α}_{D , 2} {x}_{D}^{2} + … + {α}_{C , n} {x}_{C}^{n} + {α}_{D , 1} {x}_{D}^{n} \qquad ( 4 )$$

n is fixed when selecting the fitting function,
k represents the exponent (or power) of signal x, which can be 1, 2, . . . n, and
β represents a constant bias term

For example, when k=1 the fitting function may be defined using equation 5 below:

$$f ( {α}_{C} , {x}_{C} , {α}_{D} , {x}_{D} , β ) = {α}_{C} {x}_{C} + {α}_{D} {x}_{D} + β \qquad ( 5 )$$

Further, at step 408, the method 400 may include updating the fitting parameters. In an embodiment, a group of fitting parameters may be determined based on repeated fitting on the plurality of combinations of the mixed signal and the set of single signals. The fitting may be performed for the predefined number of times. For example, the fitting is performed 1000 times.

Further, the method 400 may include estimating one or more set of distribution parameters based on the obtained group of fitting parameters. In an embodiment, each set of distribution parameters may correspond to mixed and single signals strength.

Further, the method 400 may include generating one or more ellipsoids corresponding to a number of iterations based on the estimated one or more set of distribution parameters. In an embodiment, the one or more set of distribution parameters may be utilized to form a hyperplane.

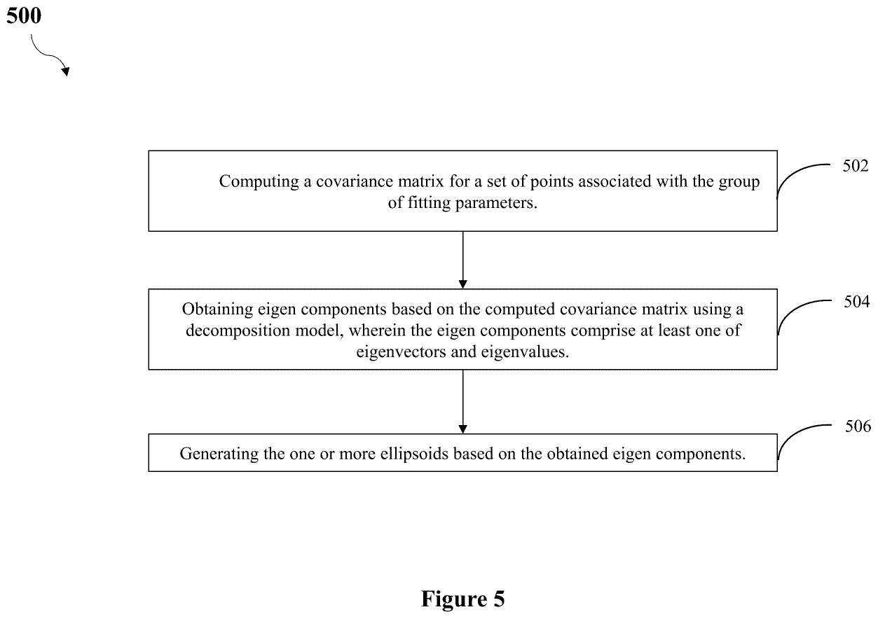

In an exemplary embodiment, a single ellipsoid may be generated using a single set of distribution parameters. Thereafter, a number of ellipsoids may be generated, for example, 10 ellipsoids based on the different set of distribution parameters. In an embodiment, the generation of the one or more ellipsoids may be explained with reference to FIG. 5.

FIG. 5 illustrates a flowchart 500 depicting sub-steps for generating the one or more ellipsoids, in accordance with an embodiment of the present disclosure.

At sub-step 502, the processor 106 may compute a covariance matrix for a set of points associated with the fitting parameters. For example, the covariance matrix may be computed for 1000 points of the fitting parameters.

Further, at sub-step 504, the processor 106 may be configured to obtain eigen components based on the computed covariance matrix using a decomposition model, specifically using singular value decomposition (SVD). However, it should be understood to the person skilled in the art that another similar model may also be used obtain the eigen components. In an embodiment, the eigen components may include eigenvectors and/or eigenvalues.

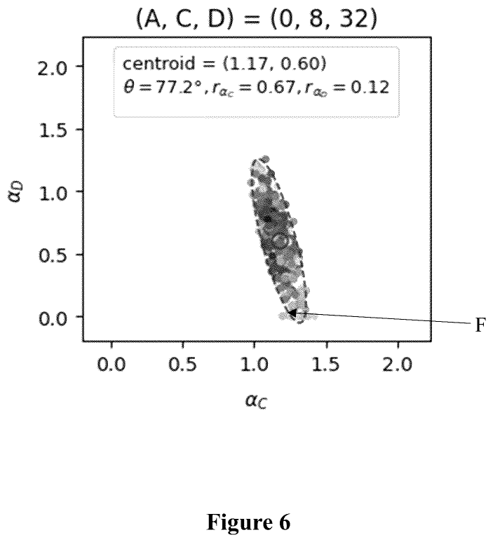

At sub-step 506, the processor 106 may be configured to obtain the distribution parameters needed to generate the ellipsoid based on the obtained eigen components. In an exemplary scenario, various parameters of the example ellipsoid illustrated in FIG. 6 which is generated using the above steps. Referring to FIG. 6, an example 2-dimensional case for the ellipsoid generated from the fitting parameters using C=8, D=32. The fitting parameters may be plotted visually with α_{C} on the horizontal axis and α_{D} on the vertical axis. In an embodiment, plotting 1000 points of the fitting parameters, a rough shape of a 2D ellipsoid is generated. The centroid may be calculated from the 1000 points, and the rotation and axis lengths parameters are from the eigen components of the covariance matrix (θ is the angle, r is the axis lengths.

In an exemplary scenario, the various distribution parameters obtained are discussed below:

$$Centroid ( {N}_{s} values ) = Mean along each axis of {α}_{k} , i . e . ( {\overline{α}}_{C} , {\overline{α}}_{D} ) \\ Rotation ( {( {N}_{s} - 1 )}^{2} values ) = Calculate the polar , azimuth , etc angle ( θ ) ( for each ( {N}_{s} - 1 ) axis . Axis lengths ( {N}_{s} values ) = {n}_{σ} \times \sqrt{eigenvalues of convariance matrix}$$

where n_{σ} is the number of standard deviations controls the proportion of points within the ellipsoid.

In an embodiment, one set of distribution parameters is corresponding to one set of different stimulant strength combination. For example,
Using C=1, D=1, generating first set of fitting parameters and the first set of distribution parameters,
C=2, D=2, generating a second set of fitting parameters and a second set of distribution parameters, and
C=3, D=3, generating a third set of fitting parameters and a third set of distribution parameters

Referring to FIG. 6, each point “F” corresponds to a fitting step. In an embodiment, it is observed that 99.7% of the data are within 30 of the mean value. In an exemplary embodiment, no may be equal to 3. However, in another embodiment, no may be modified to other values which may be greater or less than 3.

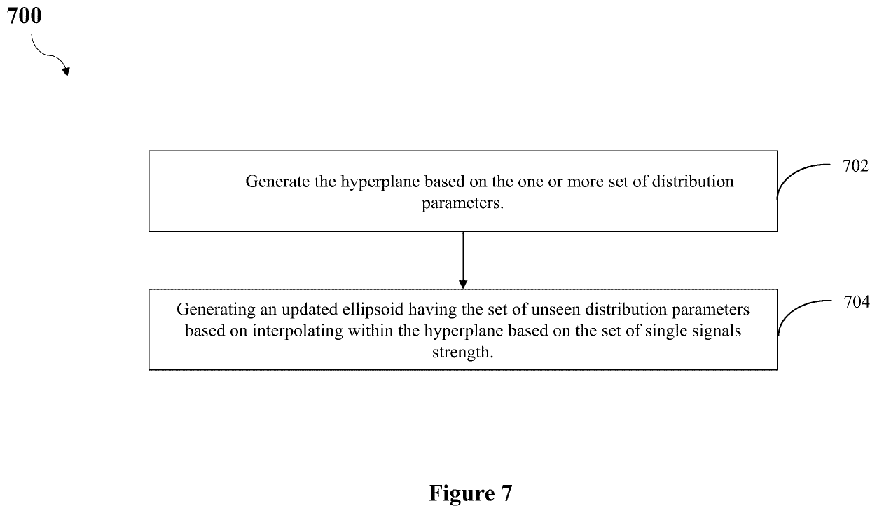

Further, the method 400 may include estimating a set of unseen distribution parameters based on the generated one or more ellipsoids. In an embodiment, the set of unseen distribution parameters may be generated based on interpolating within the hyperplane. For example, the set of unseen parameters may refer to new observations of mean and standard deviation within the hyperplane. In an embodiment, the estimation of the set of unseen parameters may be discussed in reference to FIG. 7.

FIG. 7 illustrates a flowchart 700 depicting sub-steps for estimating the set of unseen distribution parameters, in accordance with an embodiment of the present disclosure.

At sub step 702, the processor 106 may be configured to generate the hyperplane based on the one or more sets of distribution parameters. For example, 10 set of distribution parameters may be used to form the hyperplane.

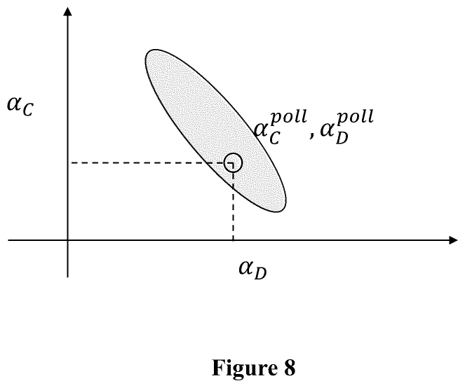

Further, at sub-step 704, the processor 106 may be configured to generate an updated ellipsoid having the set of unseen distribution parameters based on interpolating within the hyperplane based on the set of single signals strength. For example, referring to FIG. 8, using C=20, D=20, and interpolating on the hyperplane, a centroid′, θ′

$${r}_{{α}_{c = 2 {0}^{′}}}^{′} , {r}_{{α}_{D = 20}}^{′} ,$$

is obtained which is used to generate a new ellipsoid (updated ellipsoid).

In an embodiment, C and D represent different single sources of stimulants using the sensor 200 throughout the process. For example, for stimulant source C, x_{C} represents the signal response by the sensor 200 with the presence of stimulant source C, and α_{C} represents the fitting parameter associated with x_{Cz}.

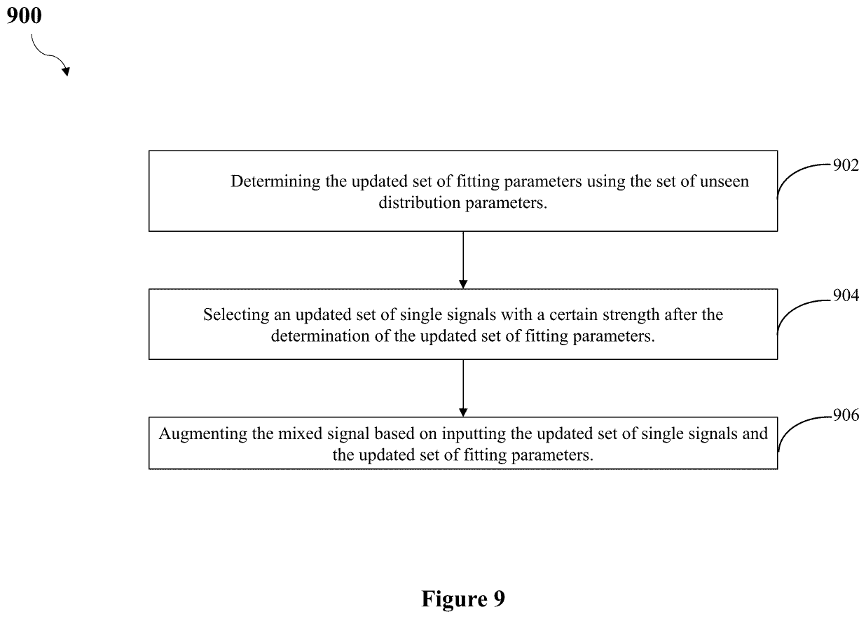

Again, referring to FIG. 4, at step 410, the method 400 may include augmenting the mixed signal based on determining an updated set of fitting parameters. In an embodiment, the augmentation of the mixed signal may be discussed with reference to FIG. 9.

FIG. 9 illustrates a flowchart 900 depicting sub-steps for augmenting the mixed signal, in accordance with an embodiment of the present disclosure.

At sub-step 902, the processor 106 may be configured to determine the updated set of fitting parameters using the set of unseen distribution parameters. More specifically, to determine the updated set of fitting parameters, a learning or the fitting model may be applied based on new data (unseen distribution parameters). For example, referring to FIG. 8, the updated fitting parameters are obtained which are shown using equation 6 below:

$${α}_{c = {20}^{′}}^{poll} , {α}_{D = 20}^{poll} \qquad ( 6 )$$

Where

$${α}_{C = {20}^{′}}^{poll} , {α}_{D = 20}^{poll}$$

represent the updated fitting parameters

Further, at sub-step 904, the processor 106 may be configured to select an updated set of single signals with a certain strength after the determination of the updated set of fitting parameters. For example, at least two query single signals with the certain strength are selected.

Furthermore, at sub-step 906, the processor 106 may be configured to augment the mixed signal based on inputting the updated set of single signals and the updated set of fitting parameters to the fitting function. In an embodiment, the sub-steps 702-706 may be repeated for a predefined number of times for example y times, to get y number of augmented mixed signal.

In an exemplary scenario, the updated set of fitting parameters which are obtained in equation (6) is input in equation (2) to augment the mixed signal which is shown in equation (7) below:

$${x}_{C = 20 , D = 20} = f ( {α}_{C = 20}^{poll} , {x}_{C = 20} , {α}_{D = 20}^{poll} , {x}_{D = 20} , 0 ) \qquad ( 7 )$$

In various embodiments, the AI model may be trained using augmented data associated with the mixed signal. The trained AI model may be used to test a real mixture data. In an embodiment, the AI Model may include but not limited to a classification model, a multi-output regression model.

In an exemplary scenario, the data is collected on C=8, 32, 64 and D=8, 32, 64 for learning the hyperplanes on the distribution parameters. In an exemplary scenario, interested in generating an augmented signal with C=16, D=16 which is unseen. Therefore, the AI model is trained on all the data:
Real data: Single sources C=8, 32, 64, D=8, 32, 64 with their mixed combinations CD=(8,8), (32,8), (64,8), (8,32), (32,32), (64,32), (8,64), (32,64), (64,64)
Augmented data: C=16, D=16, CD=(16,16)

In an embodiment, the AI model may be test with real collected data of C=16, D=16, CD=(16,16) as input. Further, a performance value of the trained AI model may be determined based on a certain intended task to predict one or more characteristics associated with the mixed signal. In an embodiment, the task may include predicting the strength of each stimulant component from the mixed signal, classification or other task required prediction based on the input mixed stimulant. Thereafter, the performance value may be compared with a preset threshold value then the trained AI model is deemed capable in executing the intended task.

In another scenario, when the performance value of the trained AI model is below the predefined threshold value, then a different fitting function may be selected at the initial step.

In various embodiments, the present disclosure at least provides the following advantages:

The present disclosure reduces the required data collection permutations from O(mⁿ) to O(mn) where m is the number of levels of stimulant strength and n is the number of the sources. Therefore, the present disclosure reduces the data collection requirement to a linear complexity.

The present disclosure enables the augmentation of the mixed signal. Therefore, the augmented data associated with the mixed signal, the AI model, for example, the machine learning model is trained with the augmented data, and this process may be iterated with different fitting functions to get the optimum model.

The embodiments disclosed herein can be implemented through at least one software program running on at least one hardware device and performing network management functions to control the elements. The elements can be at least one of a hardware device or a combination of hardware devices and software modules.

It is understood that terms including “unit” or “module” at the end may refer to the unit for processing at least one function or operation and may be implemented in hardware, software, or a combination of hardware and software.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

We claim:

1. A method (400) for augmenting a mixed signal, the method (400) comprising:
sensing a set of single signals and the mixed signal;
inputting the set of single signals and the mixed signal on a fitting function based on selecting the set of single signals and the mixed signal;
determining fitting parameters based on fitting the mixed signal with the set of single signals;
updating the fitting parameters; and
augmenting the mixed signal based on determining an updated set of fitting parameters.

2. The method (400) of claim 1 comprising:
training the AI model using augmented data associated with the mixed signal;
determining a performance value associated with the trained AI model;
determining whether the determined performance value exceeds a preset threshold value; and
predicting, via the trained AI model, one or more characteristics associated with the mixed signal based on determining that the determined performance value exceeds the preset threshold value.

3. The method (400) of claim 1 comprising:
determining a group of fitting parameters based on repeating fitting on a plurality of combinations of the mixed signal and the set of single signals, wherein fitting is performed for a predefined number of times;
estimating one or more set of distribution parameters based on the obtained group of fitting parameters, wherein each set of distribution parameters correspond to mixed and singles signal strength;
generating one or more ellipsoids corresponding to a number of iterations based on the estimated one or more set of distribution parameters, wherein the one or more set of distribution parameters form a hyperplane; and
estimating a set of unseen distribution parameters based on interpolating within the hyperplane.

4. The method (400) of claim 3, wherein generating the one or more ellipsoids comprises:
computing a covariance matrix for a set of points associated with the group of fitting parameters;
obtaining eigen components based on the computed covariance matrix using a decomposition model, wherein the eigen components comprise at least one of eigenvectors and eigenvalues; and
generating the one or more ellipsoids based on the obtained eigen components.

5. The method (400) of claim 3, comprises:
generating the hyperplane based on the one or more set of distribution parameters; and
generating an updated ellipsoid having the set of unseen distribution parameters based on interpolating within the hyperplane based on the set of single signals strength.

6. The method (400) of claim 1, wherein augmenting the mixed signal comprises:
determining the updated set of fitting parameters using the set of unseen distribution parameters;
selecting an updated set of single signals with a certain strength after the determination of the updated set of fitting parameters; and
augmenting the mixed signal based on inputting the updated set of single signals and the updated set of fitting parameters.

7. A system (100) for augmenting a mixed signal, the system (100) comprising:
a memory (102); and
at least one processor (106) in communication with the memory (102), wherein the at least one processor (106) configured to:
sense a set of single signals and the mixed signal;
input the set of single signals and the mixed signal on a fitting function based on selecting the set of single signals and the mixed signal;
determine fitting parameters based on fitting the mixed signal with the set of single signals;
update the fitting parameters; and
augmenting the mixed signal based on determining an updated set of fitting parameters.

8. The system (100) of claim 7, wherein the at least one processor (106) is configured to:
train the AI model using augmented data associated with the mixed signal;
determine a performance value associated with the trained AI model;
determine whether the determined performance value exceeds a preset threshold value; and
predict, via the trained AI model, one or more characteristics associated with the mixed signal based on determining that the determined performance value exceeds the preset threshold value.

9. The system (100) of claim 7, wherein the at least one processor (106) is configured to:
determine a group of fitting parameters based on repeating fitting on a plurality of combinations of the mixed signal and the set of single signals, wherein fitting is performed for a predefined number of times;
estimate one or more set of distribution parameters based on the obtained group of fitting parameters, wherein each set of distribution parameters correspond to mixed and singles signal strength;
generate one or more ellipsoids corresponding to a number of iterations based on the estimated one or more set of distribution parameters, wherein the one or more set of distribution parameters form a hyperplane; and
estimate a set of unseen distribution parameters based on interpolating within the hyperplane.

10. The system (100) of claim 8, wherein to generate the one or more ellipsoids, the at least one processor (106) is configured to:
compute a covariance matrix for a set of points associated with the group of fitting parameters;
obtain eigen components based on the computed covariance matrix using a decomposition model, wherein the eigen components comprise at least one of eigenvectors and eigenvalues; and
generate the one or more ellipsoids based on the obtained eigen components.

11. The system (100) of claim 9, wherein the at least one processor (106) is configured to:
generate the hyperplane based on the one or more set of distribution parameters; and
generate an updated ellipsoid having the set of unseen distribution parameters based on interpolating within the hyperplane based on the set of single signals strength.

12. The system (100) of claim 7, wherein to augment the mixed signal, the at least one processor (106) is configured to:
determine the updated set of fitting parameters using the set of unseen distribution parameters;
select an updated set of single signals with a certain strength after the determination of the updated set of fitting parameters; and
augment the mixed signal based on inputting the updated set of single signals and the updated set of fitting parameters.
